(19) United States
(12) Patent Application Publication
(10) Pub. No.: US 2013/0184916 A1
(43) Pub. Date: Jul. 18, 2013

(54) METHOD AND APPARATUS FOR ASSISTING AN ENGINE OR A DRIVE WHEEL

(71) Applicant: Johnathan Goodwin, El Dorado, KS (US)

(72) Inventor: Johnathan Goodwin, El Dorado, KS (US)

(21) Appl. No.: 13/744,876

(22) Filed: Jan. 18, 2013

Related U.S. Application Data
(60) Provisional application No. 61/587,987, filed on Jan. 18, 2012.

(51) Int. Cl. B60W 20/00; B23P 11/00; B60K 6/485

(52) U.S. Cl. CPC B60W 20/00; B60K 6/485; B23P 11/00; Y10S 903/903
USPC 701/22; 29/401.1; 180/65.26; 903/903

(57) ABSTRACT

An apparatus and method for increasing the fuel efficiency of an internal combustion engine including an electric motor and storage batteries to create a hybrid assist vehicle. The electric motor aids in the rotation of the components of the internal combustion engine including the engine crankshaft or drivetrain, and a control system aids in operation of the electric motor thereby reducing the consumption of fuel by the internal combustion engine. The apparatus and method may be used to provide electrical energy to a device separate from the components of the control system.

### CROSS-REFERENCE TO RELATED APPLICATIONS

This application claims the benefit of U.S. Provisional Application No. 61/587,987, filed Jan. 18, 2012, the contents of which are hereby incorporated by reference.

### BACKGROUND

The present disclosed technology relates generally to electrically powered vehicles and more particularly to electrical motors used to assist an internal combustion engine to increase fuel efficiency or increase engine performance of a vehicle.

The majority of automobiles, trucks, and over-the-road haulers utilize conventional, internal combustion engines. With the increasing price of fossil fuels, gasoline, and diesel fuel, the public and automobile manufacturers have turned to high-fuel mileage vehicles, electric and hybrid automobiles that utilize both electric motors and internal combustion engines. To realize the benefits of these fuel-efficient designs, the consuming public must either purchase a new automobile or alternatively, retrofit an existing vehicle with a new engine, such as one that is compatible with methanol/gasoline blends (designated as E85 in the United States) or remove the engine and replace it with an electric motor, an electrical current source such as batteries, an alternative charging system such as regenerative braking, or a small gasoline engine. Electric automobiles (also known as plug-in vehicles or plug-in hybrid electric vehicles), hybrid vehicles, and engine replacement are costly investments and may not be readably available in all markets. Furthermore, the history of these automobiles is limited and consuming public may be hesitant to purchase a vehicle with unfamiliar technology and limited service history.

One configuration of a hybrid vehicle utilizes two electric motors and an internal combustion motor. The first electric motor drives the front wheels and the second motor drives the rear. These motor are powered by batteries which are charged externally, an electrical charging station such as 110 V or 220 V and internally through regenerative braking. The internal combustion engine is typically small by volumetric standards—approximately liter having 2 or 3 cylinders. Under “charged” conditions, wherein the storage batteries have sufficient power to operate the two electric motors, all four wheels of the hybrid vehicle are under power as an all-wheel drive vehicle. However, if the voltage of the storage batteries drop below a predetermined level, the internal combustion engine engages and along with the front electric motor, drives the front wheels of the hybrid vehicle continuing to use regenerative braking and an alternator to charge the storage batteries. Once the voltage of the storage batteries is restored, the vehicle returns to the all-wheel drive configuration by the front and rear electric motors. Although electric vehicles incorporate regenerating braking to charge storage batteries, they primarily utilize external charging.

Electrical and hybrid vehicles not only use the storage batteries to provide power to the drive motors but also must use the storage batteries to provide for heating, air conditioning, power steering, windshield wipers, lights, window defrosters, and blower fans. These additional electrical needs, which may be significant, must be compensated for in the storage batteries. For example, a typical automobile heater consumes 50 Watts (W), brake lights 40 W, two windshield wipers consume approximately 80 W, and heater blower motors and electric windows each consume 150 W. Other electrical components include headlights which consume approximately 160 to 200 W and tail, marker and turn signal lights in the range of 30 to 40 W each. Electric seat position and sunroof motors also require 150 W. Thus, a full-equipped automobile with all electrical components running at once could consume up to 1.7 k W. To provide for all these necessary electrical components and added luxuries such as electrical windows and heated seats, the storage batteries must be sufficient to support these components and still drive the electrical motor to propel the vehicle. Thus, electrical and hybrid automobiles have high power demands and require large electrical storage capacity. With the need for electrical storage also increases the costs of batteries, especially state of the art lithium-ion batteries which, in return, increase the cost of the vehicle. It should also be noted that these power consuming accessories equate to reduced fuel mileage with traditional internal combustion engine vehicles. Further, there is a lack of remote charging stations for electric vehicles and current electrical vehicles have limited range.

### SUMMARY OF THE INVENTION

The present technology provides a vehicle with a hybrid assist for increasing fuel mileage over traditional internal combustion engines, as well as a method of assisting movement of an internal combustion engine. Increased fuel mileage is achieved by providing an alternative power source to a traditional internal combustion engine.

One aspect of the technology relates to a hybrid assist for a vehicle having an internal combustion engine operably connected to a drive train of the vehicle. The vehicle may include one powered by gasoline, diesel fuel, or an alternative combustible fuel such as methanol, ethanol, or biodiesel, and an electrical motor for assisting movement of the internal combustion engine.

In another aspect of the technology, the electrical motor assists movement of a drive shaft of the internal combustion engine operatively connected to the drive train of the hybrid assist vehicle.

In another aspect of the technology, the hybrid assist vehicle includes an internal combustion engine and an assist drive in the form of an electric motor which is used to assist the turning of a crankshaft of the internal combustion motor by engaging an external harmonic balancer mounted on the crankshaft. The electric motor is powered by storage batteries and actively charged through regenerative braking. A drive belt is driven by a drive pulley rotatively mounted on the output of the electric assist motor and is operatively connected to the drive-assist pulley attached to the internal combustion motor at the external harmonic balancer. Alternatively, the assist motor may engage a pulley operatively connected to the crankshaft at a drive pulley that powers a belt or series of belts that drive other components on the vehicle such as an alternative, power steering pump, air condition compressor or radiator fan.

In still another aspect of the technology, a throttle sensor is also utilized to determine the rate of speed that the driver desires at any given moment. The throttle sensor is adaptive to the type of throttle system used in the hybrid assist vehicle. In one embodiment, the internal combustion engine utilized a throttle cable connected to a carburetor or throttle body. The throttle sensor or in the example, a throttle position sensor, determines the position of the throttle cable at the fuel/air input device (carburetor or throttle body) or at the accelerator pedal in the driver's compartment. Position is typically sensed and converted into a voltage and sent to a controller. The controller senses the change of steady-state of the desired driving conditions as indicated by the position of the accelerator pedal and sends a signal to the electronic assist motor to provide rotational energy to assist the internal combustion engine.

In a further aspect of the technology, the throttle sensor is a throttle potentiometer or voltage sensor. Internal combustion engines that utilize fuel injection typically use an electronic sensor that engages the accelerator pedal. The voltage of the throttle potentiometer is sent to an electronic control unit (ECU) of the internal combustion engine which controls the fuel injection system. These fuel injection systems may utilize individual cylinder injection or a throttle body configuration and typically use other sensors to determine the rate in which fuel is injected in to the cylinders. For example, the ECU may receive also an electrical signal from a mass air-flow meter, a fuel meter, and engine speed (revolutions per minute). The ECU utilizes these signals to determine the current operating conditions of the engine and makes changes to the desired driving conditions as sensed by the throttle sensor interconnected with the accelerator pedal in the driver's compartment. The controller of the present technology also receives a signal from the ECU as well as the throttle sensor and determines the output of the signal to send to the electric assist motor to assist the turning of the engine crankshaft and thereby assisting the internal combustion engine.

In a still further aspect of the technology of the hybrid assist vehicle, the power output of the electric assist motor is determined by a controller which controls the flow of current from the storage batteries and to the electric assist motor. The controller also monitors the voltage of the storage batteries and compensates for the driver's desired driving performance such as maximum range, maximum speed for a set period of time, assisting during high power needs such as driving up hill, or other driving conditions. These aspects utilize the internal combustion engine to charge via an alternator the vehicle's original battery that provides for the ignition, windshield wipers, heater, power accessories (windows, door locks, seat positioners and heaters, interior lights, etc.), and exterior lights. Thus, the storage batteries of the hybrid assist vehicle and the electric assist motor are not used to power these components. Conversely, traditional hybrid and electric vehicles utilize the storage batteries to perform these functions which tasks which increases the demand on the storage batteries and ultimately reduces performance or driving range.

Another aspect of the present technology utilizes an electric assist motor and controller that may be installed on a traditional internal combustion vehicle such as a gasoline or diesel automobile vehicle, truck, or van. The electric motor is installed in or near the engine compartment of the vehicle along with a controller, and throttle sensor. The storage batteries are installed where space permits such as in the trunk or behind or under seats of the vehicle. In one retrofit installation of the retrofit electric assist motor to an internal combustion engine vehicle, the electric assist motor with a drive pulley is installed on an engine mount and operatively connected to the engine crankshaft by a pulley mounted to the external harmonic balancer mounted to the crankshaft. A belt translated the rotation of the drive pulley to the crankshaft of the engine. A cogged belt and toothed pulleys are used to receive the cogged belt; however, other types of belts or chain configurations are also used. This embodiment also maintains the emission and anti-pollution control systems of the internal combustion engine of as provided by the original automobile manufacturer.

One further aspect of the technology allows the driver of the hybrid assist vehicle or traditional internal combustion engine vehicle retrofitted with the electric assist motor, to select a drive mode depending upon the mode selected by the drive. The driver may desire increased fuel efficiency which is achieved by engaging the electric assist motor to assist the rotation of the internal combustion crankshaft, or alternatively, desire increased performance while driving under high load conditions such as during acceleration or driving up an incline or for maximum fuel economy over a set distance which will deplete the batteries.

### BRIEF DESCRIPTION OF THE DRAWINGS

The drawings constitute a part of this specification and include exemplary embodiments of the disclosed subject matter illustrating various objects and features thereof, wherein like references are generally numbered alike in the several views.

FIG. 1 is a block diagram of a hybrid assist vehicle;

FIG. 2 is a broken-away view of the hybrid assist vehicle illustrating an electric assist motor, internal combustion engine and a transaxle;

FIG. 3 is a perspective view of an electric assist motor of FIG. 3 installed in a vehicle;

FIG. 4 is a front elevation view of the electric assist motor of FIG. 3 installed in a vehicle;

FIG. 5 is a top plan view of the electric the electric assist motor of FIG. 3 installed on a vehicle; and

FIG. 6 is a perspective view of storage batteries for the electric assist motor of FIG. 3 and hybrid assist vehicle.

### DETAILED DESCRIPTION

As required, detailed aspects of the disclosed subject matter are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right, and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. This terminology will include the words specifically mentioned, derivatives thereof and words of similar meaning.

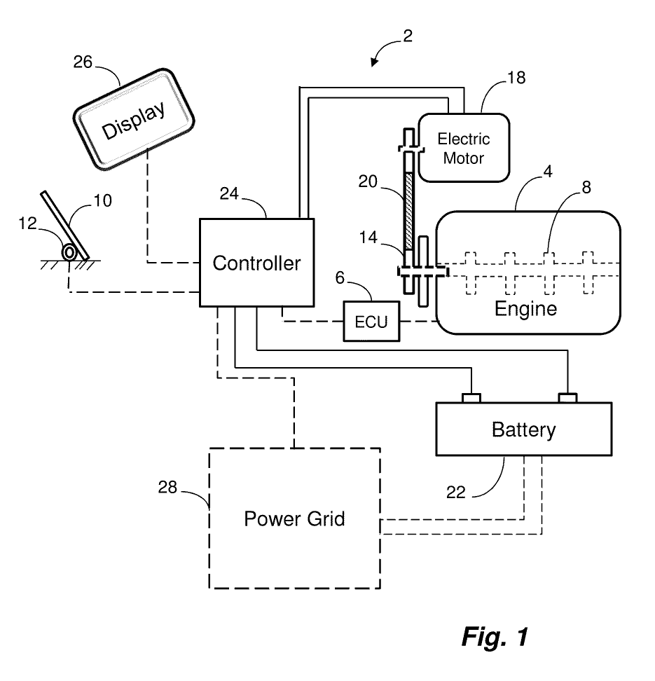

FIG. 1 is a block diagram components of a hybrid assist vehicle system 2. Hybrid assist vehicle system 2 includes a conventional internal combustion engine 4 such as one provided by the original automobile manufacture of a passenger car, truck, or commercial vehicle. In one embodiment, a Volkswagen Beatle passenger automobile (See FIG. 3) is retrofitted to create a hybrid assist vehicle. Hybrid assist vehicle system 2 also includes original equipment from the automobile manufacturer including an electronic control unit 6 (ECU), crankshaft 8 of the internal combustion engine 4 and the accelerator pedal 10. Associated with accelerator pedal 10 is a throttle sensor 12 which determines either the change in movement of the pedal or change in voltage if the automobile utilizes electronic throttle. Internal combustion engine 4 also includes a coupler 14 which is operatively connected to a crankshaft 8 of internal combustion engine 4. Most internal combustion engines utilize an exterior harmonic balancer 16 (also known as a harmonic, vibration or torsion damper) to reduce torsional vibrations of the crankshaft as it rotates due to the reciprocation of the piston in each cylinder (not shown) during the combustion cycles of internal combustion engine 4. This rotational energy is eventually transfers to the drive train including the wheels of hybrid assist vehicle to propel the vehicle.

In one embodiment of hybrid assist vehicle system 2, internal combustion engine 4 includes a harmonic balancer 16 attached to crankshaft 8 with a coupler 14 attached to harmonica balancer 16. Alternatively, for internally balanced internal combustion engines, a belt pulley (not shown) may be attached directly to crankshaft 8 and coupler 14 is attached directly to the belt pulley. Similarly, a belt pulley may be attached to crankshaft 8 as original equipment from the manufacturer. This belt pulley is used to drive engine accessories such as power steering pumps, air conditioner compressors, radiator fan, electric alternator or generator, and other assemblies and systems.

As shown in FIG. 1, coupler 14 is attached to harmonic balancer 16 and is operatively connected to an electric assist motor 18 using a belt 20. Belt 20 is preferably a toothed or cogged rubber belt, a V-belt or a chain. Alternatively, electric assist motor 18 may be operatively connected to crankshaft 8 using a messed gear system (not shown) or directly connected with mechanical fasteners to harmonic dampener 16 or crankshaft 8. Hybrid assist vehicle system 2 also includes storage battery or batteries 22 which supplies electrical current to electric assist motor 18. Also incorporated is a controller 24 for monitoring the conditions of the internal combustion engine 4, ECU 6 and throttle sensor 12, and controlling the functions of hybrid assist vehicle system 2. An interactive display 26 is also provided in the driver's compartment which relays information about hybrid assist vehicle system 2 and allows the driver to input the desired driving conditions. Lastly, a power grid 28 is shown in FIG. 1 is operably connected to the storage batteries 22 and is used to charge storage batteries 22 when the hybrid assist vehicle is not in operation. In one embodiment, 120 V current is used to charge storage batteries 22; however, 220 V current may be used as well as current generated by solar cells or wind turbines.

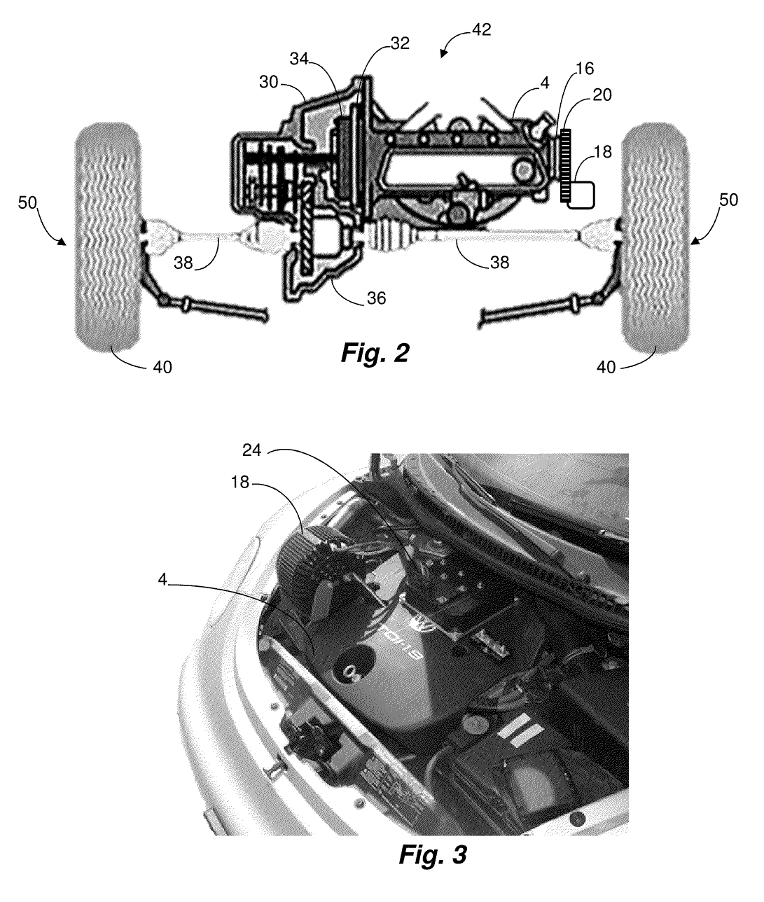

Turning to FIG. 2, a drive train 42 of a hybrid assist vehicle is shown in the form of a transaxle of a typical front wheel drive automobile with a four cylinder engine. Internal combustion engine 4 is shown with electric assist motor 18 engaging the crankshaft of internal combustion engine 4 at the harmonic balancer 16 using a belt 20. The crankshaft of internal combustion engine 4 is driven by both the combustion of fuel in the cylinders and by the rotation of electric assist motor 18. As shown in FIG. 2, the crankshaft is operatively connected to automatic transmission 30 using a flex plate 32 which is mechanically fastened to the opposite end of the crankshaft and provides rotation to the a torque converter 34. Automatic transmission 30 translates the rotational energy in one direction to a differential 36 to provide rotation of the half axle shafts 38 connected to the drive wheels 40 of the hybrid assist vehicle. It should be noted that hybrid assist vehicle system 2 may be incorporated in vehicles using manual transmissions, rear-wheel drive, and all-wheel drive vehicles.

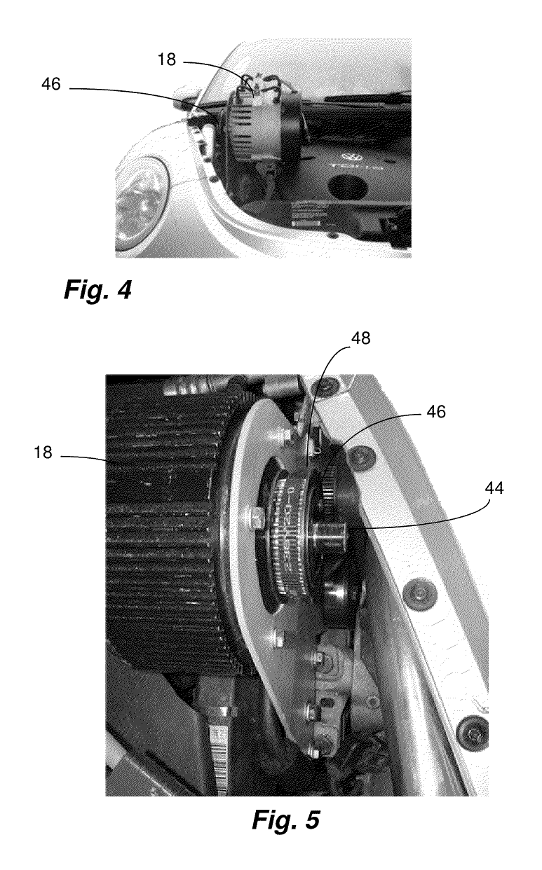

In an embodiment, the hybrid assist vehicle system 2 is shown as retrofitted to an original equipment manufactured engine in FIG. 3. Electric assist motor 18 sits slightly above the engine shield of internal combustion engine 4. As seen in this embodiment, controller 24 also is positioned on the engine shield. In one application, a high power brushless DC motor manufactured by Golden Motor Technology, Co. (Model No. HPM500B) which rotates in the range of 2,000 to 6,000 rpm, with a power rating of 3 to 7.4 kW at 24, 36, 48 or 72 Volts, 88% efficiency and weighs approximately 11 kg (24.2 pounds). Other electrical motors may be used such as E-Motors by AVL Electrification Solutions, AVL North America or eCycle, Inc., Tempe, Pa., USA. As seen in FIGS. 3 and 4, the engine compartment of the hybrid assist vehicle is very small and internal combustion engine 4 and electric assist motor 18 cannot be mounted inside the compartment. The hood of the vehicle was modified with a cowl to cover the engine compartment and electric assist motor 18. This space limitation is common with front wheel vehicles that utilize a transaxle. Rear wheel drive and all-wheel drive vehicles often have larger engine compartments or space adjacent to the engine to mount electric assist motor 18 near and in line with harmonic balancer 16 and crankshaft 8.

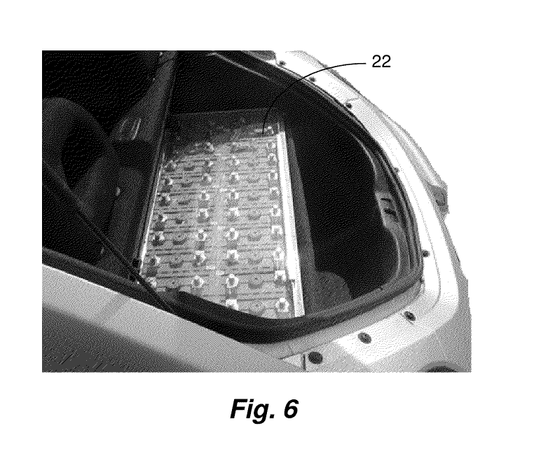

Electronic assist motor 18 is operatively connected to crankshaft 8 using a belt and pulley system as shown in FIGS. 4 and 5. The output shaft 44 of electronic assist motor 18 is seen in FIG. 5 and engages a toothed pulley 46. A toothed or cogged belt 48 engages both toothed pulley 46 of electronic assist motor 18 and (coupler 14) that operatively engages crankshaft 8 of internal combustion engine 4. Current is provided by storage batteries 22 and as shown in FIG. 6, may be mounted in the trunk of the electric assist vehicle. One embodiment used 3.5 V, 100 and 160 Amp-hour batteries by Thunderskey (Model Mo. WB-LYP100AHA and WB-LYP160AHA). Various battery configurations such as using lithium-ion SuperPolymer battery systems by Electrovaya, Toronto, Canada, may be utilized by electronic assist vehicle system 2. The costs of lithium-ion batteries varies greatly depending upon the size and weight of the batteries; therefore, the user of the electronic assist vehicle system 2 will optimize the battery configuration for the size, weight, and budget of the vehicle to be retrofitted. As shown in FIG. 6, twenty-two 3.5 V batteries were connected in series to achieve a total voltage of 77 V with shorter or longer battery life depending upon the battery used. The 100 Amp-hour batteries provide 7.7 kW-hours whereas the 160 Amp-hour batteries provide 12.3 KW-hours of operation. Storage batteries 22 may be charged by power grid 28 at 110 V in less than 3 hours for the 100 Amp-hour batteries and less than 5 hours for the 160 Amp-hour models. During operation, regenerative braking 50, such as explained in U.S. Pat. No. 7,362,065, herein incorporated by reference, is employed to charged storage batteries 22 which increases operational time and fuel mileage.

The hybrid vehicle assist system 2 includes controller 24 that receives driver inputs via display 26 and engine parameters from ECU 6, throttle sensor 12, and information regarding the status of storage batteries 22. Controller 24 incorporates a processor and memory for computing the range and availability of hybrid vehicle system 2 to increase fuel mileage, provide additional power for mountain and incline driving, or alternatively, maximum range under dual power of the electric assist motor 18 and internal combustion engine 4. For example, controller 24 adapts for the desired driving conditions including: a) City economy—short trips relying upon dual electrical and internal combustion engine modes; b) city performance—using the electrical assist motor to increase the rate of acceleration; c) highway economy—maximizes fuel economy by operating in dual electrical and internal combustion engine mode for the entire range of the storage batteries over the distance of the trip; and d) highway performance—operation in dual mode with priority given to the electric assist motor when under accelerating conditions resulting in greater performance with and slightly improved fuel economy.

In an embodiment the system 2 may also operate in stock mode whereby the user operates the vehicle as though the hybrid assist vehicle system 2 was not engaged, and the system 2 may revert back to this mode in the event of a system failure to allow the vehicle to continue to function.

In another embodiment the system 2 may operate in a performance mode whereby the user operates the vehicle with the hybrid assist vehicle system 2 assisting the internal combustion engine during normal operation to maximize fuel efficiency through the cost savings of using energy stored in the battery pack.

In another embodiment the system 2 may operate in a generator mode whereby the user operates the vehicle with the hybrid assist vehicle system 2 activated whereby the system 2 increases fuel economy by capturing the waste energy associated with deceleration or braking of the vehicle. In the generator mode the system 2 becomes a regenerative braking system that captures the waste energy from deceleration and stores it in the battery for later use.

In another embodiment the system 2 may operate in a performance mode to provide additional energy to the movement of the internal combustion engine or components of the drivetrain in addition to the energy provided by the internal combustion engine for situation where additional power is needed.

In another embodiment the system 2 may operate in an electrical power generation mode to supply electricity to a component external to the system 2, including the electrical system of a residential or commercial structure, or a machine in need of electrical energy.

In an embodiment, the system 2 modes, and monitoring of the system 2, may be controlled with a computer program operating on a computing device, including a smart phone. For example, a user may interface with the computing device and an electronic map program operating thereon to input a current location and a destination into the computing device. The computing device may analyze the input and output a proposed route on the map maximizing use of the vehicles internal combustion engine and electrical motor to efficiently use the energy of the vehicle to transport the vehicle and user from the current location to the destination. The system 2 is operably connected to the computing device and operably controls the system 2 determining the specific modes to use while moving from the current location to the destination.

When the driver starts the hybrid assist vehicle, controller 24 asks the driver to select a driving condition such as highway or city driving, requests the estimated length of the trip, and desired optimization for performance of fuel economy. Controller 24 communicates with ECU and other engine sensors to determine the available capacity of storage batteries 22, amount of fuel in fuel tank or request the driver to estimate gallons of fuel. Using these inputs and data, controller 24 determines the rate of electric fuel substitution to provide internal combustion engine 4 to meet the driver defined parameters. Controller 24 continues to monitor hybrid assist vehicle system 2 and determines engine rpm, fuel consumption, mileage, and battery capacity to adjust the rate of electric fuel substitution. Moreover, controller 24 stores trip information in memory and conditions for frequently repeated trips such as driving from home to work or school. In one embodiment, the fuel efficiency was doubled for short—30 miles—in city driving of a four cylinder, front wheel drive vehicle. Typical highway fuel economy for 60 to 90 mile trips were increased by 30 to 50%. Therefore, significant cost savings can be realized with hybrid assist vehicle system.

The electrical assist motor can provide the torque (rotational power) necessary to rotate the crankshaft of the internal combustion engine at any time during the operation of the electric assist vehicle. During idling conductions, the electric assist motor may provide the power to the internal combustion and thereby, achieving nominal, practically zero, fuel consumption. Similarly, the internal combustion engine may be used to perform 80% of the work required to rotate the crankshaft of the internal combustion engine, thereby reducing fuel consumption by 80% (80% of the work performed by the electric assist motor and 20% by the work by the fuel powered internal combustion engine.)

The hybrid assist vehicle system may be a bolt on plug in hybrid kit for existing vehicles wherein the electrical motor provides rotational energy to an internal combustion motor, a crank shaft, a drive train, etc.

The hybrid assist vehicle system provides unique advantages over currently available hybrid and electric vehicles. Additional benefits include waste energy recovery through regenerative braking, plug in cost savings due to due to fuel source performance enhancements, braking enhancements , auxiliary power capability for commercial applications, safety as a bolt on stand-alone system in the event of a failure of the system or for use with a factory internal combustion engine vehicle not having an electrical motor assist. Any vehicle utilizing a traditional internal combustion engine that has access to crankshaft of the engine may be retrofitted with the hybrid assist vehicle system. Likewise, vehicle manufacturers may incorporate the electrical assist motor during the building of a vehicle to provide for optimal placement of the electrical assist motor and storage batteries.

The hybrid vehicle is comprised of an automobile having an internal combustion engine; an electric motor; a coupler; an alternative power source; and a drive train. The hybrid vehicle wherein the internal combustion engine includes a crankshaft. The crankshaft wherein the crankshaft is operatively connected to the coupler. The hybrid vehicle wherein the coupler is operatively and connected to the electric motor. The coupler wherein the coupler is a pulley and a belt or chain system operatively connecting the electric motor to the engine. The coupler of wherein the coupler is gear system electric motor is operatively connecting the electric motor to the engine. The coupler wherein the coupler is a mechanical fastener operatively connecting the electric motor to the engine. The hybrid vehicle wherein the alternative power source is a storage battery. The hybrid vehicle wherein the engine is operatively connected to the drive train for rotating at least one pair of axles to propel the hybrid vehicle.

The method of increasing the fuel efficiency a vehicle having an internal combustion engine, the method is comprised of receiving an indication to increase the power output of the internal combustion engine; supplying current to an electrical motor in response to the indication; and rotating a crankshaft of the internal combustion engine with the output of the electrical motor. The method wherein the step of receiving an indication to increase the power output of the internal combustion engine includes receiving a signal from a throttle sensor. The method of wherein the step of rotating a crankshaft of the internal combustion engine with the output of the electrical motor includes rotating a pulley and belt system operatively joining a rotating output shaft of the electrical motor with a belt or chain with a pulley operatively connected to the crankshaft of the internal combustion engine.

It will be appreciated that the components of hybrid asset vehicle and electric assist motor can be used for various other applications. Moreover, the electric assist motor can be fabricated in various sizes and from a wide range of suitable materials, using various manufacturing and fabrication techniques.

It is to be understood that while certain aspects of the disclosed subject matter have been shown and described, the disclosed subject matter is not limited thereto and encompasses various other embodiments and aspects.

Having thus described the disclosed technology, what is claimed as new and desired to be secured by Letters Patent is:

1. A method of increasing the fuel efficiency a vehicle having an internal combustion engine the method comprising:
(a) receiving an indication to increase the fuel efficiency of the internal combustion engine from a controller;
(b) supplying current from a current source to an electrical motor in response to the indication; and
(c) rotating a crankshaft of the internal combustion engine with the output of the electrical motor.

2. A hybrid vehicle comprising:
(a) an automobile having an internal combustion engine having at least one piston associated with a combustion chamber;
(b) a crankshaft rotatively and operatively mounted to the piston wherein the reciprocating movement of the piston results in the rotation of the crankshaft;
(c) a drive train including a drive wheel operatively connected to the crankshaft for turning the drive wheel of the hybrid vehicle;
(d) a throttle sensor;
(e) an electric assist motor operatively connected to the crankshaft;
(f) at least one storage battery for providing electrical current to the electric assist motor;
(g) a controller having a processor and an internal memory and operatively connected to the storage battery;
(h) a display for displaying information from the controller to a driver and querying driver;
(i) an input device for responding to the query of the controller and for inputting driver selected modes of operation; and
(j) an algorithm operable on the processor of the controller for engaging the electrical assist motor for assisting the rotation the crankshaft of the internal combustion engine.

3. A retrofit assembly for increasing the fuel mileage of an automobile having an internal combustion engine, the assembly comprising:
(a) a coupler attached to the crankshaft of an internal combustion engine;
(b) an electric assist motor operatively and rotatively connected to the coupler;
(c) a controller having a processor and an internal memory;
(d) an display screen for displaying information from the controller to a driver;
(e) an input device for inputting driver selected modes of operation; and
(j) an algorithm operable by the processor of the controller for engaging the electrical motor for assisting the rotation the crankshaft of the internal combustion engine
(c) a controller for engaging the electrical motor for assisting the rotation of the crankshaft of the internal combustion engine.

4. A method of creating a hybrid automobile vehicle by retrofitting an internal combustion engine of an automobile wherein the internal combustion engine has a crankshaft operatively and rotatively connected to a drive train for rotating a drive wheel of the vehicle, the method comprising:
(a) installing a coupler on a harmonic balancer or a pulley attached to the crankshaft of the internal combustion engine;
(b) engaging the coupler with an electric motor;
(c) supplying electrical current from a storage battery to the electric motor; and
(d) rotating the coupler with the electric motor to rotate the drive train.
